(19) United States
(12) Patent Application Publication
(10) Pub. No.: US 2017/0113252 A1
(43) Pub. Date: Apr. 27, 2017

(54) METHOD AND RELEASE COATING COMPOSITION FOR PROVIDING CLEANING ASSISTANCE

(71) Applicant: 3M INNOVATIVE PROPERTIES COMPANY, St. Paul, MN (US)

(72) Inventors: Andrew T.J. van Bommel, London, Ontario (CA); Naiyong Jing, St. Paul, MN (US); Mohit Malik, Calgary (CA); Tony R. Carrozzella, London, Ontario (CA); Bethany A. Turowec, Calgary (CA); Bradley M. Berven, Halls Head (AU); S.M. Ibrahim Al-Rafia, Calgary (CA)

(21) Appl. No.: 15/309,358

(22) PCT Filed: May 4, 2015
(86) PCT No.: PCT/US2015/028994

§ 371 Date: Nov. 7, 2016

Related U.S. Application Data
(60) Provisional application No. 62/137,503, filed on Mar. 24, 2015.
(60) Provisional application No. 61/990,073, filed on May 7, 2014.

(51) Int. Cl. B08B 3/02; B60S 3/04; C11D 17/06; C09D 7/12; C11D 11/00; B08B 3/08; B05D 1/02

(52) U.S. Cl. CPC B08B 3/02; B08B 3/08; B60S 3/04; B05D 1/02; C09D 7/1216; C09D 7/1266; C11D 11/0023; C11D 11/0058; C11D 17/06

(57) ABSTRACT

A method of facilitating the removal of bitumen-containing mud from a substrate includes coating the substrate with a composition comprising nanoparticles and water, such that the bitumen-containing mud that adheres to the coated substrate may be more easily removed from the substrate than from an uncoated substrate. In one embodiment, the composition assists an aqueous terpene-based detergent to more effectively clean bitumen-containing mud from the painted steel undercarriages of trucks used in oil sands operations.

### BACKGROUND

The present disclosure relates to cleaning and, more particularly, to methods and compositions for facilitating the removal of contaminants from a surface.

Oil sands are a type of unconventional petroleum deposit in which oil is contained in a predominantly solid phase. In oil sands, oil is contained in tar or bitumen, which in turn is contained within sand or dirt. Bitumen is the oil in the oil sands. Bitumen is a naturally occurring viscous mixture of hydrocarbons with a consistency of molasses and an America Petroleum Institute (API) gravity of 8-14. Bitumen molecules contain thousands of carbon atoms. This makes bitumen one of the most complex molecules found in nature. On average, bitumen is composed of about 83.2% carbon, 10.4% hydrogen, 0.94% oxygen, 0.36% nitrogen, and 4.8% sulfur. Oil sands are hydrophilic (i.e. water wet). Each grain of sand is covered by a film of water, which is surrounded by heavy oil (i.e. bitumen).

In surface mining applications, a bitumen/dirt mixture is transported from the originating site using large dump trucks known as “heavy haulers” with, for example, a 400 tonne capacity. In the process of transporting the oil sands, the trucks accumulate large amounts of unwanted material on the undercarriage of the truck. The material, which are often referred to as “mud”, may comprise, for example, debris such as bitumen, clay and/or limestone.

The mud build-up is most severe in the hot spots on the underside of the truck, behind the front wheels, on rubber hoses, and on other components. The accumulation of the mud results in: a) increased weight of the truck leading to a decrease in the load available to be carried, and b) difficulty in accessing parts in the undercarriage for maintenance. Oil and gas trucks undergo scheduled washings when they are in the field. For heavy haulers, the trucks are washed approximately every month. Bitumen-containing muds are especially difficult to remove from a substrate, especially a steel substrate, once the mud is adhered thereto, in part due to the bitumen's hydrophobicity and in part to the stickiness of the bitumen lending a strong bond between the mud and the substrate. Therefore, washing the trucks is laborious and time-consuming, with washing times taking hours per truck. The time that the trucks are being washed adds to the total maintenance time and therefore the down-time of the trucks.

### SUMMARY

In view of the above, there is a need to shorten wash times of vehicles, such as trucks and other heavy equipment, used in oil sand operations. Prior attempts to solve the bitumen build-up problem have used superhydrophobic coatings. One of the primary shortcomings associated with superhydrophobic technologies, however, is their lack of durability. Superhydrophilic coatings have also been known to suffer from a lack of durability. The release coating compositions described herein, however, were found to have surprisingly good durability. Even water borne release coating compositions that contain no binder according to the present invention were found to withstand more than one wash cycle, and often withstood up to three or more wash cycles before reapplication of the release coating was needed. Water borne coatings according to the present invention are believed to be quite thin (i.e. on the order of less than 1 micrometer thick). Because these water borne compositions are so thin, and because they do not contain a binder to increase their durability, one would expect them to quickly dissolve and wash away during washing, or be removed from the substrate as a result of the harsh operating conditions (e.g. abrasive action from the mud and sand either alone or in combination with spray washing). The extended durability of the present release coating compositions, particularly those that do not contain a binder, was surprising and unexpected. Because the present hydrophilic coatings have superior durability than previous coatings, they are better able to provide lasting cleaning assistance than previously known coatings.

In one aspect, the present invention provides a method of facilitating the removal of bitumen-containing mud from a substrate. The method comprises coating, or otherwise treating, the substrate with a composition comprising nanoparticles and water. When coated in this manner, the bitumen-containing mud that adheres to the coated substrate may be more easily removed from the substrate than from an uncoated, or untreated, substrate.

In more specific aspects, the nanoparticles may be at least one of silica nanoparticles, alumina nanoparticles, titania nanoparticles, alumina coated silica nanoparticles, and mixtures thereof. In another aspect, the nanoparticles may comprise at least one of fumed silica and colloidal silica. In a specific embodiment, the nanoparticles may be spherical silica nanoparticles.

In one embodiment, the release coating composition may be provided in concentrated form, and in another embodiment, the release coating composition may be provided in diluted form. In concentrated form, the release coating composition may comprise at least about 10 weight percent (wt %), at least about 15 wt %, or at least about 20 wt % nanoparticles, up to about 45 wt %, up to about 50 wt % or up to about 55 wt % nanoparticles. In diluted form, the composition may comprise at least about 0.001 wt %, 0.01 wt % or 0.02 wt % nanoparticles to no greater than about 10 wt %, 15 wt % or 20 wt % nanoparticles. In a specific embodiment, the release coating composition comprises from about 2 wt % to about 15 wt % spherical silica nanoparticles.

In a more specific embodiment, the spherical silica nanoparticles may have an average diameter of less than about 60, less than about 150 or less than about 300 nanometers. In another aspect, the spherical silica nanoparticles may comprise a mixture of nanoparticles having different average particle diameters. In yet another aspect, the mixture of nanoparticles may comprise greater than about 50% spherical silica nanoparticles having an average particle diameter of between about 50 nanometers and about 70 nanometers, and less than about 50% spherical silica nanoparticles having an average particle diameter of less than about 10 nanometers.

In another aspect, the composition may further comprise surfactant. Suitable surfactants may comprise cationic surfactant, non-ionic surfactant, anionic surfactant, or combinations thereof.

In another aspect, the release coating composition has a pH of from about 2 to about 10. In a more specific aspect, the composition has a pH of from about 3 to about 9. In yet another aspect, the composition may comprise sufficient acid to adjust the pH to a range of about 3 to about 9. In a specific embodiment, the acid comprises phosphoric acid.

In other aspects, the method may further comprise removing the bitumen-containing mud from the substrate with a spray of water or an aqueous detergent. In a more specific aspect, the aqueous detergent may comprise terpenes hydrocarbons, glycol and nonionic surfactant.

In one embodiment, aqueous detergent may be sprayed to contact the coated substrate and/or the bitumen-containing mud adhered to the coated substrate. In a more specific embodiment, pressurized water may be used to wash the bitumen-containing mud from the substrate after the coated substrate and/or the bitumen-containing mud adhered thereto is contacted with the aqueous detergent. In a more specific embodiment, the aqueous detergent may be mixed with a batch of the composition during or after contacting the aqueous detergent with the substrate to which bitumen-containing mud is adhered. In specific aspects, the aqueous detergent may comprise ≦10 wt % terpenes hydrocarbons, ≦15 wt % glycol and ≦10 wt % nonionic surfactant blend in water.

In one aspect, the substrate may comprise a metal, glass, rubber or plastic surface. The surface may further comprise a coating. Coatings may include, for example, epoxy, enamel, urethane or paint.

In one aspect, the substrate may be part of a vehicle used in the recovery of bitumen containing material. In other aspects, the substrate may be any surface exposed to bitumen-like materials such as tar or asphalt. In a specific aspect, the bitumen-containing mud may comprise at least about 0.1 wt %, at least about 1%, or at least about 2 wt % bitumen to no greater than about 15 wt %, not greater than 12%, or no greater than about 10 wt % bitumen.

In another aspect, the substrate may be wet when the substrate is coated with the release coating composition.

In another aspect, the present invention provides a release coating composition for use on equipment exposed to bitumen containing material, wherein the composition may comprise silica nanoparticles, surfactant and water, and the surfactant may be an anionic surfactant, the acid may be phosphoric acid, and the composition may have a pH of 2-9.

In yet another aspect, the present invention is directed toward a construction vehicle used in the recovery of bitumen containing material, wherein the vehicle has an exposed surface treated with a release coating composition comprising silica nanoparticles.

The compositions and methods described herein should not be limited to any particular type of vehicle. However, the compositions and methods described herein are particularly useful for facilitating the removal of bitumen-containing mud from the undercarriages of, for example, construction equipment and vehicles, such as trucks, heavy haulers and other equipment used in oil sand operations.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1A depicts a steel panel painted with yellow alkyd paint and covered with 16 g of a mud containing 2 wt % bitumen;

FIG. 1B depicts a steel panel painted with yellow alkyd paint, coated with a spherical silica nanoparticle composition and covered with 12 g of a mud containing 2 wt % bitumen;

FIG. 2A depicts the steel panel of FIG. 1A after being dried in an oven at 80° C. for 30 minutes;

FIG. 2B depicts the steel panel of FIG. 1B after being dried in an oven at 80° C. for 30 minutes;

FIG. 3A depicts the steel panel of FIG. 2A after being washed with a spray of water for 30 seconds;

FIG. 3B depicts the steel panel of FIG. 2B after being washed with a spray of water for 30 seconds;

FIG. 4A depicts the steel panel of FIG. 3A after being soaked for 5 minutes in 0.5 mL of Megasol™ detergent and then washed with a spray of water for 30 seconds;

FIG. 4B depicts the steel panel of FIG. 3B after being soaked for 5 minutes in 0.5 mL of Megasolυ detergent and then washed with a spray of water for 30 seconds;

FIGS. 5A1, 5A2, 5B1, and 5B2 depict the steel panels of FIG. 4A and FIG. 4B cut into top and bottom halves;

FIGS. 6A1, 6A2, 6B1, and 6B2 depict the halves of the steel panels of FIG. 5 after being washed with a spray of water for 30 seconds; and,

FIGS. 7A1, 7A2, 7B1, 7B2 depict the halves of the steel panels of FIG. 6 after being soaked for 5 minutes in 0.5 mL of Megasol™ detergent and then washed with a spray of water for 30 seconds.

### DETAILED DESCRIPTION

A method of facilitating the removal of bitumen-containing mud from a substrate comprises coating or treating the substrate with a release coating composition comprising nanoparticles and water. When treated in this manner, the bitumen-containing mud that adheres to the coated substrate may be more easily removed from the substrate than from a substrate that has not been coated or treated with the release coating composition. In one embodiment, the composition to assist in cleaning the bitumen-containing mud from the substrate is a nanoparticle based composition. The nanoparticles may comprise, for example, silica nanoparticles, alumina nanoparticles, titania nanoparticles, alumina coated silica nanoparticles, and mixtures thereof. The shape of the nanoparticles is not limited and can be any shape, regular or irregular. In more specific embodiments, the nanoparticles may comprise fumed silica and/or colloidal silica. In a particular embodiment, the nanoparticles may comprise spherical silica nanoparticles.

In one embodiment, the release coating composition may comprise an aqueous dispersion comprising at least about 0.001 wt %, at least about 0.01 wt %, at least about 0.02 wt %, at least about 1 wt % or at least about 2 wt % nanoparticles up to no greater than about 55 wt %, no greater than about 50 wt %, no greater than about 45 wt %, no greater than about 20 wt %, no greater than about 15 wt %, or no greater than about 10 wt %. In a specific embodiment, the release coating composition comprises between about 2 wt % and about 15 wt % spherical silica nanoparticles having an average particle diameter of no greater than about 300, not greater than about 150 or no greater than about 60 nanometers. As used herein, weight percent refers to the weights based on total weight of the composition. It will be recognized that the release coating composition may include a mixture of nanoparticles having different average particle diameters. In other embodiments, the composition may optionally include at least about 0.001 wt %, at least about 0.01 wt %, or at least about 0.02 wt % surfactant to no greater than about 2 wt %, no greater than about 1.5 wt %, or no greater than about 1 wt % surfactant. Suitable surfactants include cationic surfactants, non-ionic surfactants, anionic surfactants, or combinations thereof.

Suitable anionic surfactants include, but are not limited to, those with molecular structures comprising (1) at least one hydrophobic moiety, such as from about C6 to about C20 alkyl, alkylaryl, and/or alkenyl groups, (2) at least one anionic group, such as sulfate, sulfonate, phosphate, polyoxyethylene sulfate, polyoxyethylene sulfonate, polyoxyethylene phosphate, and the like, and/or (3) the salts of such anionic groups, wherein said salts include alkali metal salts, ammonium salts, tertiary amino salts, and the like. Representative commercial examples of useful anionic surfactants include sodium lauryl sulfate, available under the trade name TEXAPON L-100 from Henkel Inc., Wilmington, Del. A particularly suitable anionic surfactant useful in the release coating compositions of the present invention is sodium dodecyl sulfate (CH₃(CH₂)₁₁OSO₃Na).

Suitable neutral surfactants include polyethoxylated alkyl alcohols such as Surfynol SE-F, available from Air Products and Chemicals Inc., Allentown, Pa.

Suitable cationic surfactants include cetyltrimethylammonium bromide, available from Sigma Aldrich, St. Louis, Mo.

In certain embodiments, the release composition may have a pH value of at least about 2 or at least about 3, and a pH value of no greater than about 10, no greater than about 9 or not greater than about 6. The release coating composition may optionally include sufficient acid to adjust pH to a pH value to a range of about 2-10 or about 3-9. Suitable acids include inorganic acids such as phosphoric acid (H₃PO₄), nitric acid, hydrochloric acid, sulfuric acid, and the like. In one embodiment, phosphoric acid may be present in an amount ranging from about 0.05 to about 0.15 wt %. While the presence of a mineral acid, such as phosphoric acid, to adjust the pH is desirable for many applications, the release coating composition is surprisingly effective without the addition of acid.

While not wishing to be bound by theory, controlling the amounts of the various components, such as the water, nanoparticles, surfactant and acid, appears to provide synergy between a silica-based composition and an aqueous detergent that may be used to clean the bitumen-containing mud from the substrate.

In one embodiment, the nanoparticles may comprise fumed silica or colloidal silica. In a preferred composition, the nanoparticles may be spherical nanoparticles that may be present in an amount of about 2-15 wt %, and the surfactant may be sodium dodecyl sulfate that may be present in an amount of about 0.01-1 wt %.

Silica nanoparticles useful in compositions of the present invention preferably have a volume average particle diameter of no greater than about 300, no greater than 150 or no greater than about 60 nanometer (nm). In a preferred embodiment, the silica nanoparticles are spherical silica particles having a volume average particle diameter in a range of from 2 to 60 nm. The silica particles may have any particle size distribution consistent with the above 60 nm volume average particle diameter. For example, the particle size distribution may be monomodal or polymodal (e.g. bimodal).

Spherical silica particles in aqueous media, which may also be referred to as sols or colloidal silica, are known in the art and are available commercially. For example, silica sols in water are available under the trade designations NALCO™ from Nalco Chemical Co., Naperville, Ill. One useful silica sol with a volume average particle size of 60 nm is available as NALCO™ 1060 from Nalco Chemical Co. Another useful commercially available silica sol is available as NALCO™ 1115 with a volume average particle diameter of 4 nm. The spherical silica nanoparticles preferably comprise a mixture of nanoparticles having different average particle diameters, for example a mixture of about 50% spherical silica nanoparticles having an average particle diameter of 60 nanometers and about 50% spherical silica nanoparticles having an average particle diameter of 4 nanometers. Silica nanoparticles are further described in United States Patent Publication 2012/0029141 published Feb. 2, 2012, the entire contents of which are herein incorporated by reference.

Other useful nanoparticle materials include Ludox-CL and Ludox HS-40 colloidal silica available from W. R. Grace & Co., Columbia, Md., AERODISP 740X fumed titanium dioxide available from Evonik Industries AG, Essen, Germany, and NYACOL AL25 colloidal alumina available from Nyacol Nano Technologies, Inc., Ashland, Mass.

The release coating composition may include other optional additives such as, for example, binders and rheological modifiers, although compositions without such additives are effective and are considered within the scope of the invention. Suitable binders include, for example, poly(ethylene glycol) (PEG), poly(vinyl alcohol) (PVA), and latexes that include polyurethane dispersions and acrylic dispersions. Suitable rheology modifiers include, for example, hydrophobically modified ethylene oxide urethane (HEUR), cellulosics and clays. The nanoparticle release coating compositions described herein have been found to assist in the removal of bitumen-containing mud from a substrate to which the mud is adhered. The bitumen-containing mud may be removed from the substrate using ordinary water, using an aqueous detergent such as a terpene-based detergent, or combinations thereof. In particular, a silica-based release coating composition has been found to assist in removing bitumen-containing mud from a substrate to which the mud is adhered using a terpene-based detergent. A suitable terpene-based detergent may comprise an aqueous mixture of terpenes hydrocarbons, glycol and nonionic surfactant in water, for example <10 wt % terpenes hydrocarbons, <15 wt % glycol and <10 wt % nonionic surfactant blend in water, weights based on total weight of the aqueous detergent. Such a detergent is commercially available as MEGASOL™ from Biosol™, Calgary, Alberta, Canada. In one embodiment, the silica-based composition and the aqueous terpene-based detergent may be blended to form a cleaning composition. The aqueous detergent may be mixed with a batch of the silica-based composition before, during or after contacting the aqueous detergent with the substrate.

A method for assisting cleaning of a bitumen-containing mud from a substrate may involve coating the substrate with the nanoparticle-based composition so that bitumen-containing mud that adheres to the coated substrate may be more easily removed from the substrate with the aqueous detergent. Coating the substrate may be accomplished by generally known methods, for example spray coating, brushing, rolling, dipping, pouring and the like. Spraying the nanoparticle-based composition is generally preferred. Over-spray is generally not considered detrimental to the cleaning process. In fact, an advantage of spraying, and hence over-spray, is that the over-spray may coat other surrounding surfaces of, for example, vehicles, such as the glass or clear plastic surfaces of headlights and windows of vehicles. In this manner, the wettability of these other surfaces will be altered such that water wets and therefore less easily runs off the other surfaces. The composition may be coated on the substrate when the substrate is wet or dry. Coating the composition on a wet substrate has the advantage that pre-drying of the substrate is not required, and the advantage that the composition more readily spreads across the surface of the substrate, both of which reduce cleaning time in the field. The nanoparticle-based composition may be dried after application to the substrate. Despite comprising a large proportion of water, the composition dries remarkably quickly.

In one embodiment, cleaning the bitumen-containing mud from the coated substrate involves contacting the aqueous detergent with the coated substrate and/or the bitumen-containing mud on the coated substrate. The aqueous detergent may be contacted with the coated substrate and/or the bitumen-containing mud on the coated substrate by any suitable method, for example by soaking in a pool of the aqueous detergent or by spraying the aqueous detergent to contact the coated substrate and/or the bitumen-containing mud adhered thereto. Spraying the aqueous detergent is generally preferred. The aqueous detergent may be allowed to soak into the bitumen-containing mud for a period of time (e.g. several minutes or an hour or more). The aqueous detergent and bitumen-containing mud may then be washed from the substrate using water or using more of the aqueous detergent. That is, the washing process may be accomplished by spray washing the substrate with water or with more aqueous detergent. The spray washing process may be accomplished in a single step process using a relatively high pressure spray (e.g. at least 100 psi), or the spray washing process may be accomplished in a two-step process using a first low pressure wash (e.g. less than about 50 psi) followed by a soak, followed by a second low pressure wash. To conserve aqueous detergent, a high pressure spray of water is generally preferably used. Repeating the contacting of the aqueous detergent with the coated substrate and/or the bitumen-containing mud adhered thereto followed by repeating the high pressure spraying may be required in particularly difficult cases.

In a cleaning operation, the nanoparticle-based composition and the aqueous detergent may be applied sequentially or simultaneously to the substrate. In some circumstances, the nanoparticle-based composition may be applied to the substrate first, such as when the substrate is manufactured, or just before use of the substrate in the field. In other circumstances, such as after the substrate has already seen service in the field, the aqueous detergent may be used first to clean the substrate and the nanoparticle-based composition applied subsequently. In yet other circumstances, it may be beneficial to apply the aqueous detergent and the silica-based composition simultaneously, either by mixing the two together and spraying the mixture or spraying the two in separate streams but simultaneously. Applying both the nanoparticle-based composition and the aqueous detergent at the same time offers the advantage of reducing cleaning time. Because substrate cleaning is cyclical, a cycle of aqueous detergent use, water use, and application of nanoparticle-based composition may be established. Depending on the working life of a single coating of nanoparticle-based composition, the nanoparticle-based composition may be applied during or after each cleaning or during or after two or more cleanings with the aqueous detergent. In some embodiments, a single coating of the nanoparticle-based composition may last for at least one, two, three or more cleaning cycles, depending on the end use conditions, before the composition is reapplied to the substrate.

The compositions and methods are not limited to a specific substrate, although the compositions and methods are especially suited for application to steel substrates, particularly painted steel, such as steel used in connection with construction vehicles. Steel painted with epoxy and alkyd paint, such as the steel used on trucks and other heavy equipment employed in the oil and gas industry are of particular note. In a specific embodiment, the substrate is a coated substrate. The coating on the substrate may be, for example, epoxy, a high gloss enamel finish, or a urethane high-gloss top coat. In a specific situation, the substrate may include a painted surface painted with, for example, a paint available from Caterpillar Inc. Peoria, Ill., such as a yellow aerosol or bulk paint.

The compositions and methods described herein are of particular use in the cleaning of vehicles, especially trucks and other heavy equipment to which bitumen-containing mud has adhered as a result of their use in bitumen-contaminated areas such as oil sands. However, the compositions and methods could be applied to other vehicles that are used in other mining operations, in connection with road resurfacing equipment, or used in connection with regular cleaning operations, such as the washing of vehicles in standard car wash facilities because the compositions also assist in removing tar, asphalt and normal mud (i.e. dirt and water without bitumen) from the contaminated surface. Still, the compositions and methods are particularly useful in removing bitumen-containing mud from surfaces. Bitumen-containing mud may contain, for example, from at least about 0.1 wt %, 0.5 wt %, or 1 wt %, to no greater than about 5 wt %, no greater than about 10 wt %, no greater than about 15 wt %, no greater than about 20 wt % bitumen, or more depending on the extent to which the area has been exposed to bitumen. For example, the release coating composition may be effective in assisting the removal of bitumen-containing muds comprising up to 25 wt % bitumen.

### EXAMPLES

### Example 1

Two steel panels were prepared by painting them with a yellow alkyd paint commonly used on heavy trucks and other equipment employed in areas in which the dirt is contaminated with bitumen. The painted steel panels were washed with water. One of the still wet steel panels was coated with a solution of 5 wt % spherical silica nanoparticles (50/50 Nalco™ 1060 and 1115), 0.1 wt % sodium dodecyl sulfate (SDS) surfactant and 0.1 wt % phosphoric acid (H₃PO₄) in 94.8 wt % water using a Graco™ sprayer. The other panel remained uncoated. Both the coated and uncoated panels were then allowed to air dry, which took about 10 minutes.

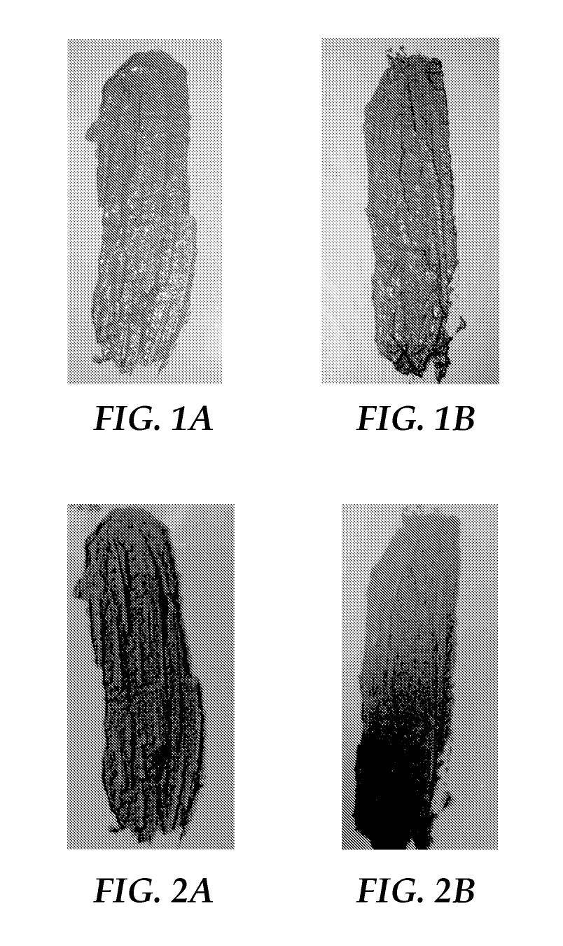

The dried panels were then covered with mud containing 2 wt % bitumen. The bitumen was an authentic oil sands sample obtained from Syncrude Corp., Fort McMurray, AB, Canada. The uncoated panel was covered with 16 g of the bitumen-containing mud and the panel coated with the silica composition was covered with 12 g of the bitumen-containing mud as illustrated in FIG. 1A and FIG. 1B, respectively. FIG. 1A illustrates the mud-covered panel that was not coated with the silica and FIG. 1B illustrates the mud-covered panel that was coated with the silica.

The two mud-covered panels were then dried in an oven at 80° C. for 30 minutes, which mimics how mud dries onto heavy trucks in the field. The resulting panels covered with dried bitumen-containing mud are shown in FIG. 2A and FIG. 2B, where FIG. 2A illustrates the dried mud-covered panel that was not coated with the silica and FIG. 2B illustrates the dried mud-covered panel that was coated with the silica. It is evident that both panels comprise a relatively thick covering of mud.

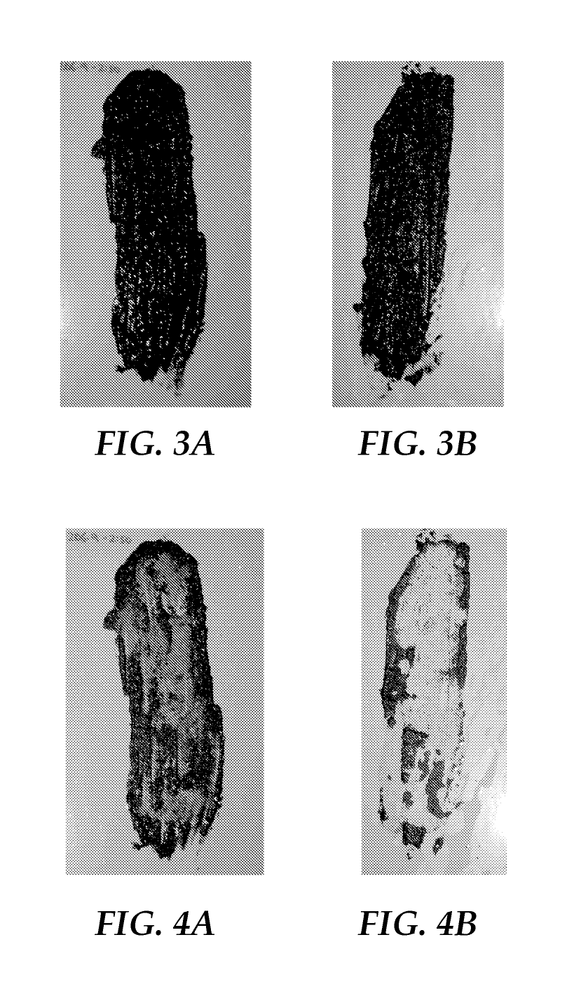

Both panels were then spray-washed with relatively low pressure water (i.e. the measured pressure ranged from approximately 25-35 psi) for 30 seconds using a hose and spray nozzle attached to a water faucet. The panels after spraying with water are illustrated in FIG. 3A and FIG. 3B, where FIG. 3A illustrates the panel that was not coated with the silica and FIG. 3B illustrates the panel that was coated with the silica. It is evident from FIG. 3A and FIG. 3B that washing with relatively low pressure water for 30 seconds resulted in modest mud removal from the panels.

Both panels were then soaked for 5 minutes in 0.5 mL of Megasol™ detergent. Megasol™ is a detergent from Biosol™ comprising <10 wt % terpenes hydrocarbons, <15 wt % glycol and <10 wt % nonionic surfactant blend in water. Megasol™ is a detergent product used by the oil industry to wash trucks and other equipment employed in oil sands. After soaking in Megasol™, the panels were spray-washed with relatively low pressure water (i.e. approximately 25-35 psi) for 30 seconds using a hose and spray nozzle attached to a water faucet. As shown in FIG. 4A and FIG. 4B, the panel originally coated with spherical silica nanoparticles (FIG. 4B) was cleaned more effectively than the panel that was originally uncoated (FIG. 4A). The amount of bitumen-containing mud removed (i.e. washed away) from the coated panel was 7.2 g representing 60% of the original amount of mud, while the amount of bitumen-containing mud removed (i.e. washed away) from the uncoated panel was 5.5 g representing 34% of the original amount of mud.

Thus, it can be seen that when using relatively low pressure water (e.g. <50 psi) to remove bitumen-containing mud from a substrate, a detergent, such as Megasol™ detergent, can be used to significantly increase the overall removal rate of the bitumen-containing mud. That is, the detergent and nanoparticles appear to work together synergistically to significantly increase the amount of bitumen-containing mud that is removed from the substrate. While not wishing to be bound by any particular theory, when using relatively low pressure water during the rinsing step, the detergent appears to facilitate the removal of bulk material from the substrate while the silica nanoparticle composition appears to facilitate the removal of material from the interface between the material and the substrate. In this manner, the detergent and nanoparticles work together to provide and highly effective combination that allows contaminant material to be removed from the substrate using relatively low pressure water. Thus, Example 1 shows that using a spherical silica nanoparticle composition to assist with bitumen-containing mud removal using Megasol™ detergent results in reduced usage of detergent and water, as well as shortened cleaning times for trucks and other equipment employed in areas where the dirt is contaminated with bitumen, e.g. oil sands.

### Example 2

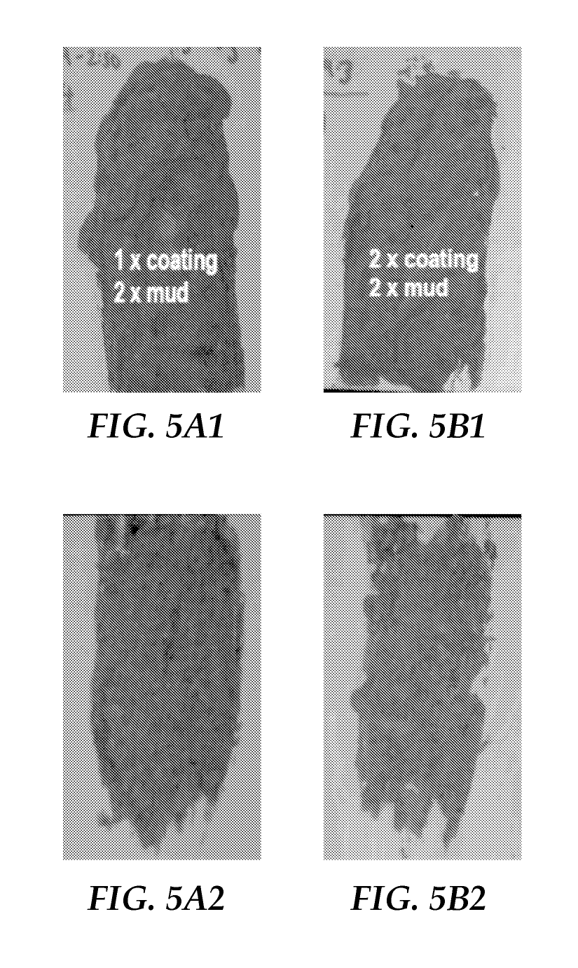

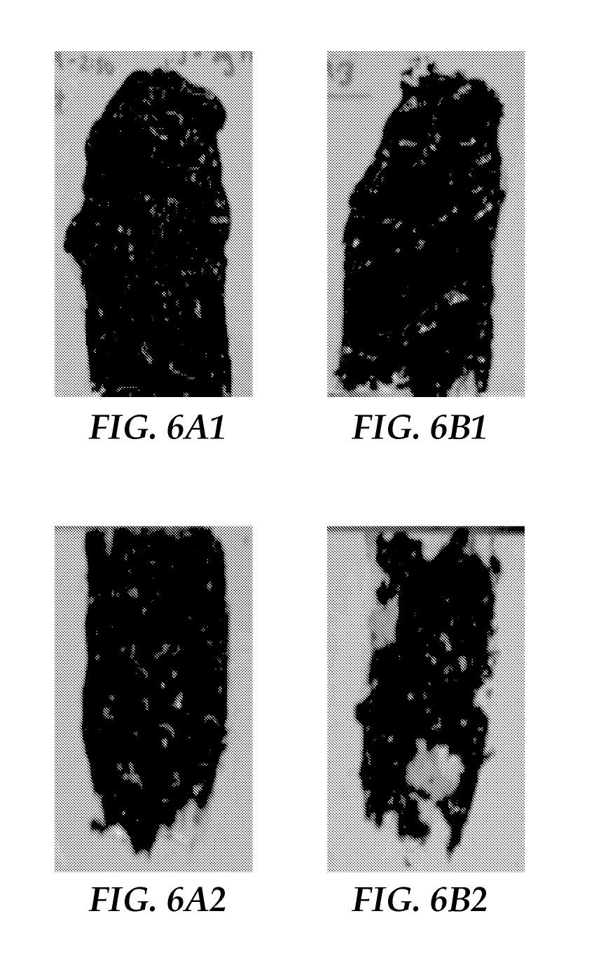

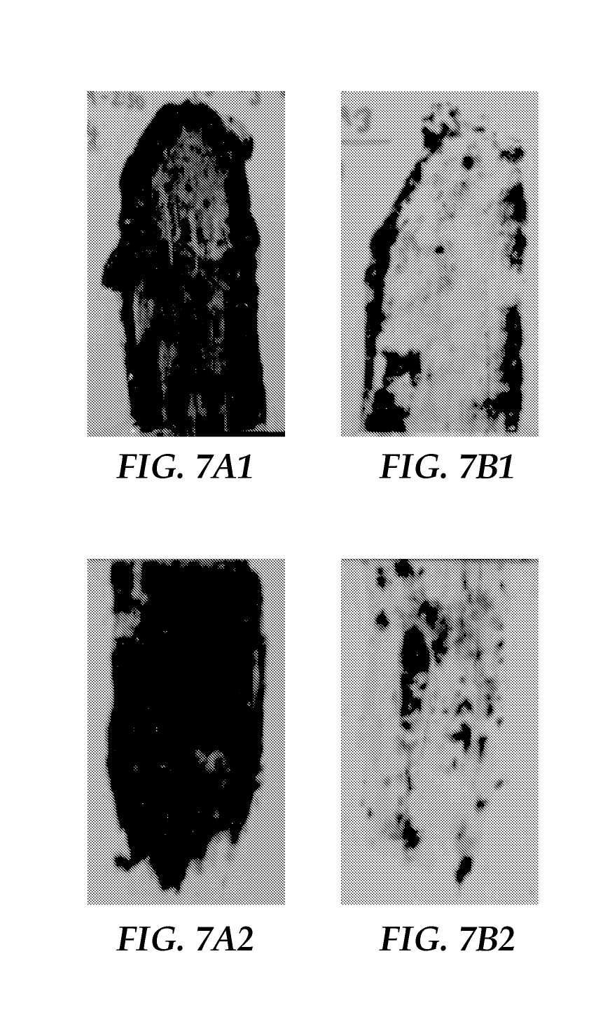

With reference to FIGS. 5A1, 5A2, 5B1, 5B2, FIGS. 6A1, 6A2, 6B1, 6B2, and FIGS. 7A1, 7A2, 7B1, 7B2, this example explored the effect of a second cleaning cycle on the panels of FIG. 4A and FIG. 4B. The steel panels of FIG. 4A and FIG. 4B with the remains of the bitumen-containing mud thereon were dried and cut in half across the panels' widths.

The top halves were recoated over the remaining bitumen-containing mud with the same silica-based composition as described in Example 1 except that the panels were dry when the silica-based coating was applied. After recoating the top halves with the silica-based composition and drying in air for 10 minutes, the top half of the panel of FIG. 4A (in FIGS. 5A1, 6A1 and 7A1) was covered with an additional 8.0 g of the bitumen-containing mud, and the top half of the panel of FIG. 4B (in FIGS. 5B1, 6B1 and 7B1) was covered with an additional 6.4 g of the bitumen-containing mud. The two top halves were dried in an oven at 80° C. for 30 minutes. The two top halves with dried bitumen-containing mud thereon were then spray-washed with water for 30 seconds using a hose and spray nozzle attached to a water faucet (approximately 25-35 psi). The two top halves were then soaked for 5 minutes in 0.5 mL of Megasol™ detergent and then spray-washed with water for 30 seconds using a hose and spray nozzle attached to a water faucet (at a pressure of approximately 25-35 psi).

The bottom halves were not recoated with the silica-based composition. Instead, the top halves were directly covered over the remaining bitumen-containing mud with an additional layer of bitumen-containing mud. The bottom half of the panel of FIG. 4A (in FIGS. 5A2, 6A2 and 7A2) was covered with an additional 5.7 g of the bitumen-containing mud, and the bottom half of the panel of FIG. 4B (in FIGS. 5B2, 6B2 and 7B2) was covered with an additional 4.6 g of the bitumen-containing mud. The two bottom halves were dried in an oven at 80° C. for 30 minutes. The two bottom halves with dried bitumen-containing mud thereon were then spray-washed with water for 30 seconds using a hose and spray nozzle attached to a water faucet (at a pressure of about 25-35 psi). The two bottom halves were then soaked for 5 minutes in 0.5 mL of Megasol™ detergent and then spray-washed with water for 30 seconds using a hose and spray nozzle attached to a water faucet (at a pressure of about 25-35 psi).

From FIGS. 7B1 and 7B2 it is evident that the initial coating of silica-based composition permitted the removal of a majority of the bitumen-containing mud from the surface of the steel panel, even if a second coating of silica-based composition was not applied before the second wash cycle (as in FIG. 7B2). Thus, one coating of silica-based composition can assist the removal of bitumen-containing mud by the aqueous detergent for at least two wash cycles before the coating needs to be reapplied.

Further, comparing the panel in FIG. 7A1 to the panel in FIG. 4A, it is evident that application of the coating of silica-based composition to a surface already encrusted with bitumen-containing mud at least allows the surface to be cleaned back to its original state, indicating that the surface of steel does not have to be completely clean to start with, permitting successful use of the coating on trucks and other equipment that have already seen extensive operations in the field.

### Example 3

A steel circular panel about 12-18 inches in diameter was sprayed with a yellow paint primer commonly used on heavy trucks and other equipment employed in areas in which the dirt is contaminated with bitumen, and dried for 1 hour. Two coatings of a gloss finish were then applied and the panel was allowed to dry overnight, or until no longer tacky/sticky. Half of the panel was then sprayed with a coating of a composition comprising 95 wt % water, 5 wt % nanosilica (85/15 Nalco™ 1060 and 1115), 0.1 wt % SDS and enough H₃PO₄ to bring the composition to a pH in a range of about 2.5-4. The composition was sprayed in a thick, fanned stream onto the panels and allowed to dry for at least 15 minutes. The other half of the panel was a control and was left uncoated.

The durability of the coating was tested by spray blasting half of the panel with water using a pressure washer at a higher pressure (1000 psi) and the other half of the panel with water at a lower pressure (100 psi). The half of the panel spray blasted at higher pressure included half of the coated area and half of the uncoated area and the half of the panel spray blasted at lower pressure included the other half of the coated area and the other half of the uncoated area. Thus, the panel comprised four experimental quadrants: uncoated control/low pressure, uncoated control/high pressure, coated/low pressure and coated/high pressure. Spray blasting with water was performed in 4 intervals for 2 minutes in each interval.

Photographs of the panel were taken before and after each interval and the change in contact angle of water droplets on the surface of the panel was observed visually. Where the surface was coated with the coating, the surface was more wettable and flatter water droplets were observed. Where the surface had no coating, the surface was less wettable (due to the hydrophobic gloss finish) and the droplets were more spherical. As the coating wore away, the droplets became more spherical. A rating scale for wettability was developed as follows: 5=full wettability, 3=wettable, 1=poor wettability. Table 1 provides the results.

TABLE 1

| Water Spray Blasting | Control | Coated |
|---|---|---|
| None | 1 | 5 |
| 1000 psi, Interval 1 | 1 | 3 |
| 100 psi, Interval 1 | 1 | 4 |
| 1000 psi, Interval 2 | 1 | 3 |
| 100 psi, Interval 2 | 1 | 3 |
| 1000 psi, Interval 3 | 1 | 2 |
| 100 psi, Interval 3 | 1 | 3 |
| 1000 psi, Interval 4 | 1 | 2 |
| 100 psi, Interval 4 | 1 | 2 |

It is evident from Table 1 that the coating lasts on the painted panel for at least 3 wash cycles before being worn off, and that this durability is independent of spray wash pressure, at least between 100 and 1000 psi. Given that the coating is hydrophilic and the painted surface is hydrophobic, this durability is remarkable, especially under high pressure water wash cycles. As coating durability has been a problem in the art, the present composition addresses this problem.

### Example 4

A steel circular panel was prepared as described in Example 3, except that the uncoated control half was replaced by coating that half with a coating composition that did not comprise any H₃PO_{4,} but was otherwise the same as the acidified coating composition. Thus, the pH of the non-acidified coating composition was slightly basic (pH˜8.5) rather than acidic, and the panel had one half coated with an acidified coating composition and the other half coated with a non-acidified coating composition. Coating durability tests at high pressure (1000 psi) were conducted as described in Example 3 and the results shown in Table 2, where 5=full wettability, 3=wettable, 1=poor wettability.

TABLE 2

| Water Spray Blasting | Non-acidified Coating | Acidified Coating |
|---|---|---|
| None | 5 | 5 |
| 1000 psi, Interval 1 | 4 | 4 |
| 1000 psi, Interval 2 | 3 | 3 |
| 1000 psi, Interval 3 | 3 | 3 |
| 1000 psi, Interval 4 | 2 | 2 |

It is evident from Table 2 that there is no difference in wettability deterioration between the acidified and non-acidified coatings, which is surprising in view of the prior art. Therefore, the use of H₃PO₄ to lower the pH of the composition is not required. This example further verifies that the composition provides a coating that lasts at least three wash cycles before being worn off.

### Example 5

A steel circular panel was prepared as described in Example 3, except that the circle was divided into three sections where: a first section was coated with a composition comprising 95 wt % water, 5 wt % nanosilica (85/15 Nalco™ 1060 and 1115), 0.1 wt % SDS and enough H₃PO₄ to bring the composition to a pH in a range of about 2.5-4; a second section was coated with a prior art superhydrophobic composition (Never-Wet™); and a third control section was left uncoated. Never-Wet™ is a superhydrophobic composition comprising 30 wt % liquefied petroleum gas, 20 wt % aliphatic hydrocarbon, 15 wt % n-butyl acetate, 15 wt % methyl isobutyl ketone, 15 wt % methyl acetate, 10 wt % ethyl acetate and 5 wt % polypropylene.

The coated circular panel was then caked with bitumen-containing mud. The bitumen-containing mud was prepared by shear mixing 300 g of 15% bitumen-mud (obtained from Shell Canada Ltd., Muskeg River Site, AB, Canada) and 230 g of clay-mud in 300 mL water for about 1 hour (or until fully mixed into a sticky paste). Using a spatula, the mud-paste was applied to the steel panel in an even layer. The muds were then fully air-dried at ambient conditions, which took approximately 4 days.

The mud-coated panel was placed in a sink and blasted for 2 minutes with high pressure water (around 1000 psi) and sprayed systematically across the panel. Videos were captured to observe and compare coating performance, i.e. mud-removal efficacy between coated and uncoated panels. Panels were sprayed until most of the mud was removed, and photographs before (when mud is dried) and after washing are also captured to observe the differences in cleanliness achieved between the coated and uncoated portions.

Re-caking the panel with bitumen-containing mud as described above, followed by re-spraying with water was repeated in several intervals and the results recorded for each interval.

A rating scale to rate cleaning effectiveness was developed based on the amount of mud build-up. In order of the amount of buildup from less to more, the scale is: No Residue, Little Residue, Some Residue, More Residue, Heavy Residue. Table 3 provides the results.

TABLE 3

| | | | Nanosilica |
|---|---|---|---|
| Water Spray Blasting | Uncoated | Never-Wet ™ | Coating |
| 1000 psi, Interval 1 | Little residue | Little residue | No residue |
| 1000 psi, Interval 2 | Some residue | Some residue | Little residue |
| 1000 psi, Interval 3 | More residue | More residue | Little residue |

### Example 6

Bitumen-containing mud is particularly sticky to the painted steel surfaces commonly used on heavy trucks and other equipment employed in areas in which the dirt is contaminated with bitumen. However, other muds, for example clay muds, also adhere to the painted steel surfaces. The durability and effectiveness of the coating for clay-mud vs. bitumen-mud were compared to each other and an uncoated surface.

Two steel circular panels were prepared as described in Example 3. Half of each panel was sprayed with a coating of a composition comprising 95 wt % water, 5 wt % nanosilica (85/15 Nalco™ 1060 and 1115), 0.1 wt % SDS and enough H3PO4 to bring the composition to a pH in a range of about 2.5-4. The composition was sprayed in a thick, fanned stream onto the panels and allowed to dry for at least 15 minutes. The other half of each panel was left uncoated. One panel was then coated with bitumen-mud as described in Example 5. The other panel was coated with a clay-mud using the same coating procedure as described in Example 5. The clay-mud was prepared by shear mixing 550 g dry, crushed clay-mud from the field (obtained from Syncrude Canada Ltd., Mildred Lake Site, AB, Canada) in 350 mL water for about 1 hour (or until fully mixed into a sticky paste). Spray washing of the two panels caked with mud was performed as described in Example 5. Table 4 provides the results. In order of the amount of buildup from less to more, the scale is: No Residue, Little Residue, Some Residue, More Residue, Heavy Residue.

TABLE 4

| Water Spray Blasting | Coating | Clay-mud | Bitumen-mud |
|---|---|---|---|
| 1000 psi, Interval 1 | Uncoated | No residue | Some residue |
| | Coated | No residue | No residue |
| 1000 psi, Interval 2 | Uncoated | Little residue | More residue |
| | Coated | No residue | Little residue |
| 1000 psi, Interval 3 | Uncoated | Some residue | Heavy residue |
| | Coated | Little residue | Some residue |

It is clear from Table 4 that bitumen-mud adheres to the painted steel panel more than the clay-mud, therefore bitumen-containing mud is harder to clean than clay-mud. The results in Table 4 further corroborate that coatings of the present composition are effective at assisting the cleaning of bitumen-containing mud from the painted steel panels even over 3 washing cycles.

Collectively, the results show that an aqueous composition of 2-15 wt % of spherical silica nanoparticles having an average particle diameter of 60 nanometers or less and 0.01-1 wt % of sodium dodecyl sulfate, with or without the inclusion of mineral acid to adjust pH, works better at assisting removal of bitumen-containing mud from a substrate than other compositions. Coatings formed from these hydrophilic compositions are notably durable on hydrophobic substrates independent of wash pressure.

The inventive features will become apparent to those of skill in the art upon examination of the description. It should be understood, however, that the scope of the claims should not be limited by the embodiments, but should be given the broadest interpretation consistent with the wording of the claims and the specification as a whole.

1.-25. (canceled)

26. A method of facilitating the removal of bitumen-containing mud from a substrate, the method comprising coating the substrate with a composition comprising nanoparticles and water, wherein the bitumen-containing mud that adheres to the coated substrate may be more easily removed from the substrate than from an uncoated substrate.

27. The method of claim 26, wherein the nanoparticles comprise at least one of silica nanoparticles, alumina nanoparticles, titania nanoparticles, alumina coated silica nanoparticles, or fumed silica nanoparticles.

28. The method of claim 26, wherein the nanoparticles comprise at least one of fumed silica or colloidal silica.

29. The method of claim 26, wherein the nanoparticles are spherical silica nanoparticles.

30. The method of claim 29, wherein the composition comprises 2 to 15 wt % spherical silica nanoparticles.

31. The method of claim 29, wherein the silica nanoparticles have an average diameter of less than about 300 nanometers.

32. The method of claim 29, wherein the spherical silica nanoparticles comprise a mixture of nanoparticles having different average particle diameters.

33. The method of claim 32, wherein the mixture of nanoparticles comprises greater than about 50% spherical silica nanoparticles having an average particle diameter of between about 50 nanometers and about 70 nanometers, and less than about 50% spherical silica nanoparticles having an average particle diameter of less than about 10 nanometers.

34. The method of claim 26, wherein the composition further comprises surfactant.

35. The method of claim 34, wherein the surfactant comprises sodium dodecyl sulfate.

36. The method of claim 26, wherein the composition has a pH of from about 2 to about 10.

37. The method of claim 26, wherein the method further comprises removing the bitumen-containing mud from the substrate with at least one of water or an aqueous detergent.

38. The method of claim 37, wherein the aqueous detergent comprises terpenes hydrocarbons, glycol and nonionic surfactant.

39. The method of claim 37, wherein the aqueous detergent is sprayed to contact at least one of the coated substrate or the bitumen-containing mud adhered to the coated substrate.

40. The method of claim 39, wherein the aqueous detergent comprises less than about 10 wt % terpenes hydrocarbons, less than about wt % glycol and less than about 10 wt % nonionic surfactant blend in water.

41. The method of claim 26, wherein the substrate comprises at least one of metal, glass, rubber, or synthetic plastic material.

42. The method of claim 41, wherein the substrate further comprises a coating comprising at least one of epoxy, enamel, urethane, or alkyd paint.

43. The method of claim 26, wherein the mud comprises from about 0.1 to about 10 wt % bitumen.

44. A release coating composition for use on equipment exposed to bitumen containing material, the composition comprising silica nanoparticles, surfactant, and water, and wherein the surfactant is an anionic surfactant, the acid is phosphoric acid, and the composition has a pH of 2-5.

45. A construction vehicle used in the recovery of bitumen containing material, wherein the vehicle has an exposed surface treated with a release coating composition comprising silica nanoparticles.
